(19) United States
(12) Patent Application Publication
(10) Pub. No.: US 2018/0245266 A1
(43) Pub. Date: Aug. 30, 2018

(54) HYDRAULIC LEVELING BASE AND WASHING MACHINE

(71) Applicants: QINGDAO HAIER WASHING MACHINE CO., LTD., Qingdao, Shandong (CN); QINGDAO HAIER SMART TECHNOLOGY R&D CO., LTD., Qingdao, Shandong (CN)

(72) Inventors: Zhiqiang ZHAO, Qingdao, Shandong (CN); Sheng XU, Qingdao, Shandong (CN)

(73) Assignees: QINGDAO HAIER WASHING MACHINE CO., LTD., Qingdao, Shandong (CN); QINGDAO HAIER SMART TECHNOLOGY R&D CO., LTD., Qingdao, Shandong (CN)

(21) Appl. No.: 15/753,365

(22) PCT Filed: Jun. 29, 2017
(86) PCT No.: PCT/CN2017/090833

§ 371 Date: Feb. 19, 2018

(30) Foreign Application Priority Data
Jun. 30, 2016 (CN) 201610511049.2

(51) Int. Cl. D06F 39/12; A47B 91/16; F16M 7/00

(52) U.S. Cl. CPC D06F 39/125; F16M 2200/08; F16M 7/00; A47B 91/16

(57) ABSTRACT

A hydraulic leveling base comprises a bracket which can be used in a combination and connection manner or independently and a leveling foot mounted below the bracket. Above the bracket is a supporting surface for bearing. A hydraulic medium is provided inside the leveling foot and can flow inside the leveling foot and/or between the leveling feet to achieve the leveling. In the present disclosure, the leveling foot is provided below the bracket of the hydraulic leveling base, the hydraulic medium flows inside the leveling foot and/or between the leveling feet, and so the amount of compression of the leveling foot under bigger pressure is large, the leveling foot under smaller pressure can extends by the action of the liquid pressure, and then automatic height leveling can be achieved.

### TECHNICAL FIELD

The present disclosure relates to a technical field of washing machine, and specifically relates to a hydraulic leveling base and washing machine.

### BACKGROUND

A leveling device is generally set at the bottom of a housing of a household appliance, and the household appliance can be stabilized by adjusting the leveling device when placing them. After leveling, the leveling device can support the household appliance to make it keep stable.

Taking a washing machine as an example, bolt feet are generally installed in the bottom of a housing or in the bottom of the whole machine of existing washing machines. The bolt foot comprises a screw, a nut gasket and a rubber pad. The nut gasket can rotate up and down on the screw, and the screw can rotate up and down in a screw hole of the bottom board of the housing. The adjustment of the height of the washing machine can be achieved by the length that the screw of the bolt foot is screwed into the bottom board. The foot of most washing machines are rotated counterclockwise to increase the height of the washing machine, and rotated clockwise to decrease the height of the washing machine. After adjustment of the height of the foot, the nut gasket which prevents loosening is tightened to keep it stable.

The foot of the washing machine mentioned above realizes the leveling of the washing machine, but it requires users to adjust manually. If the weight of the washing machine is relatively large or the installation space is small, it is very inconvenient for users to operate. Furthermore, the vibration of the washing machine during long working process also has an effect on the leveling foot and it is very easy to lead to failure of the support and to result in the washing machine being placed uneven.

For example, the existing 8 KG drum washing machine is generally about 80 Kg, which is relatively heavy, and it is very inconvenient for users to adjust. Even if the adjustment is completed, it also cannot guarantee that the washing machine is adjusted to the best condition. When the washing machine is in the washing stage, especially when the rotation speed accelerates from 0 r/min to about 1400 r/min in the spinning and dehydration stage, a great vibration will be generated once the problems of being non-level or failure of the support of the washing machine exists, it will greatly affects the comforts of use of the consumers.

Furthermore, the vibration caused by the uneven state of the washing machine may lead to the loosen state of the foot screw and vertical movement of the foot bracket. This instability may change the level state of the washing machine and results in more intense vibration. This vicious cycle makes the noise of the washing machine become bigger and bigger after a long time of use, and it will cause a certain damage to the washing machine itself and shorten the service life.

Therefore, the leveling of the existing washing machine is with the problems of manual adjustment, time-consuming and labor-consuming and poor accuracy.

In the view of foregoing, the present disclosure is proposed.

### SUMMARY

In order to solve problems above, a first object of the present disclosure is to provide a hydraulic leveling base. In particular, technical solutions as follows are adopted.

A hydraulic leveling base comprises a bracket being used in a combination and connection manner or independently, and a leveling foot mounted below the bracket. A supporting surface for bearing is on an upper part of the bracket, and a hydraulic medium is provided inside the leveling foot and flows inside the leveling foot and/or between the leveling feet for automatic leveling.

Further, a horizontal beam connecting two brackets is comprised, the bracket is provided with a hollow structure therein and an end of the bracket is provided with an inserting opening communicated with the hollow structure. And two ends of the horizontal beam are respectively inserted into the inserting openings of two brackets and are fixed inside the hollow structure, so that two brackets are connected as a whole structure.

Further, four brackets are provided and the bracket comprises two sides perpendicular to each other. The two sides are provided with the hollow structure therein and the ends of two sides are respectively provided with the inserting opening. And four horizontal beams are provided and inserted into the inserting openings of four brackets sequentially and fixed in the brackets, so that four brackets are connected as one square frame.

Further, first connecting and fixing holes are respectively provided on the two sides of the bracket perpendicular to each other in a direction of the hollow structure being provided, a second connecting and fixing hole is provided on the horizontal beam,

one or at least two first connecting and fixing holes are provided, and at least two or one second connecting and fixing hole is correspondingly provided,

the second connecting and fixing hole is adjusted to correspond to the first connecting and fixing hole, and

a connecting piece passes through the second connecting and fixing hole and the first connecting and fixing hole for fixedly connecting, to adjust a length of the horizontal beam inserted into the hollow structure of the bracket.

Further, a plurality of concentric ripple reinforcing ribs and radial reinforcing ribs perpendicular to the ripple reinforcing ribs are provided on the supporting surface of the bracket. An outer edge of the bracket is set higher than the supporting surface.

Further, the leveling foot comprises a fixed part and a movable part. A hollow chamber is formed by the fixed part and the movable part, and the hollow chamber is provided with the hydraulic medium.

The hollow chambers of two adjacent leveling feet are respectively communicated with each other by the high-pressure oil pipe group. Or, all leveling feet are respectively connected with a communicating device through the high-pressure oil pipe group to for mutual communication of the hollow chambers of all leveling feet.

Under the action of the pressure, the hydraulic medium flows between the hollow chambers of the feet communicated with each other. The movable part expands and contracts with the flow of the hydraulic medium to level automatically.

Further, the hollow chambers of two adjacent leveling feet are communicated with each other by the high-pressure oil pipe group with. A hollow channel for allowing the high-pressure oil pipe group to pass is provided inside the horizontal beam.

Further, all leveling feet are respectively connected with the communicating device through the high-pressure oil pipe group for the mutual communication of the hollow chambers of all leveling feet. The hydraulic leveling base comprises diagonal connecting beams. Two ends of the diagonal connecting beam are respectively connected with two brackets set diagonally. A hollow channel for placing the high-pressure oil pipe group and communicating device is provided inside the diagonal connecting beam.

A second object of the present disclosure is to provide a washing machine with any of the hydraulic leveling bases described above. In particular, technical solutions as follows are adopted.

A washing machine comprises a housing and a drum assembly inside the housing for washing clothes, and four corners of the bottom of the housing are placed on four brackets of the hydraulic leveling base.

Further, the housing comprises a bottom board. Four corners of the bottom board are provided with bolt feet. The bolt feet are respectively placed on four brackets of the hydraulic leveling base.

Below the bracket of the hydraulic leveling base of the present disclosure is provided with the leveling foot. The hydraulic medium can flow inside the leveling foot and/or between the leveling feet. So the amount of compression of the leveling foot under bigger pressure is large, the leveling foot under smaller pressure can extends by the action of the liquid pressure, so that automatic height leveling is achieved.

The leveling foot of the hydraulic leveling base of the present disclosure, according to the hydraulic principle, is able to perform timely and effective adjustments based on the practical application environment. It results in better adjustment effect and stronger applicability.

The hydraulic leveling base of the present disclosure can be applied to some occasions or devices which requires relatively high placement stability, to realize better leveling effect.

The washing machine of the present disclosure is placed on the hydraulic leveling base for automatic leveling. The hydraulic leveling base is also able to self-level on the partial load during a washing process and a dewatering process of the washing machine, and then lower vibration and less noise is achieved.

### BRIEF DESCRIPTION OF THE DRAWINGS

FIG. 1 is a stereoscopic structure diagram of a washing machine of an embodiment of the present disclosure.

FIG. 2 is a decomposing schematic diagram of a housing and a hydraulic leveling base of the washing machine of the embodiment of the present disclosure.

FIG. 3 is a front view of the washing machine of an embodiment of the present disclosure.

FIG. 4 is a sectional view of the washing machine of the embodiment of the present disclosure taken along section B-B in FIG. 3.

FIG. 5 is a stereoscopic structure diagram of the hydraulic leveling base of the embodiment of the present disclosure.

FIG. 6 is a stereoscopic structure diagram of the back of the hydraulic leveling base of the embodiment of the present disclosure.

FIG. 7 is a front view of the hydraulic leveling base of the embodiment of the present disclosure.

FIG. 8 is a sectional view of the hydraulic leveling base of the embodiment of the present disclosure taken along section C-C in FIG. 7.

FIG. 9 is a stereoscopic structure diagram of the leveling foot of the embodiment of the present disclosure.

FIG. 10 is an exploded view of the structure of the leveling foot of the embodiment of the present disclosure.

FIG. 11 is a front view of the leveling foot of the embodiment of the present disclosure.

FIG. 12 is a side view of the leveling foot of the embodiment of the present disclosure.

FIG. 13 is a sectional view of the leveling foot of the embodiment of the present disclosure taken along G-G-direction in FIG. 11.

FIG. 14 is a sectional view of the leveling foot of the embodiment of the present disclosure taken along H-H-direction in FIG. 11.

FIG. 15 is a sectional view of the leveling foot of the embodiment of the present disclosure taken along J-J-direction in FIG. 12.

FIG. 16 is a sectional view of the leveling foot of the embodiment of the present disclosure after being completely compressed taken along J-J-direction in FIG. 12.

FIG. 17 is a schematic diagram of the leveling feet in a state of assembly installation of an embodiment of the present disclosure.

FIG. 18 is a schematic diagram of the leveling feet in a state of assembly installation of another embodiment of the present disclosure.

FIG. 19 is a schematic diagram of the leveling foot in a working state of the embodiment of the present disclosure.

### REFERENCE SIGNS

1-base body 101-mounting hole 2-oil nipple 201-anti-stripping boss 202-guiding mechanism 203-first oil nipple 204-second oil nipple 205-third oil nipple 3-sheath 301-vertiacl limiting groove 4-adjustable foot 401-vertical limiting protrusion 5-elastic gasket 6-flexible accommodating body 601-bellows section 602-small-diameter structure 603-sealing mechanism 604-opening 7-orifice 8-valve opening 9-housing 901-bottom board 902-upper board 903-front board 904-side board 10-foot 11-pressing ring 12-clamp 13-high-pressure oil pipe group 1301-first high-pressure oil pipe 1302-second high-pressure oil pipe 1303-third high-pressure oil pipe 14-control panel 15-communicating device 16-ground 1601-gound pit 17-door 18-cover board 19-bolt foot 20-detergent box 21-hydraulic leveling base 2101-bracket 2102-protrusion edge 2103-radial reinforcing ribs 2104-ripple reinforcing ribs 2105-horizontal beam 2106-inserting opening 2107-first connecting and fixing hole 2108-reinforcing ribs 2109-second connecting and fixing hole 2110-hollow structure.

### DETAILED DESCRIPTION

The following is further and specific description of a hydraulic leveling base and washing machine of the present disclosure with accompanying drawings.

### Embodiment 1

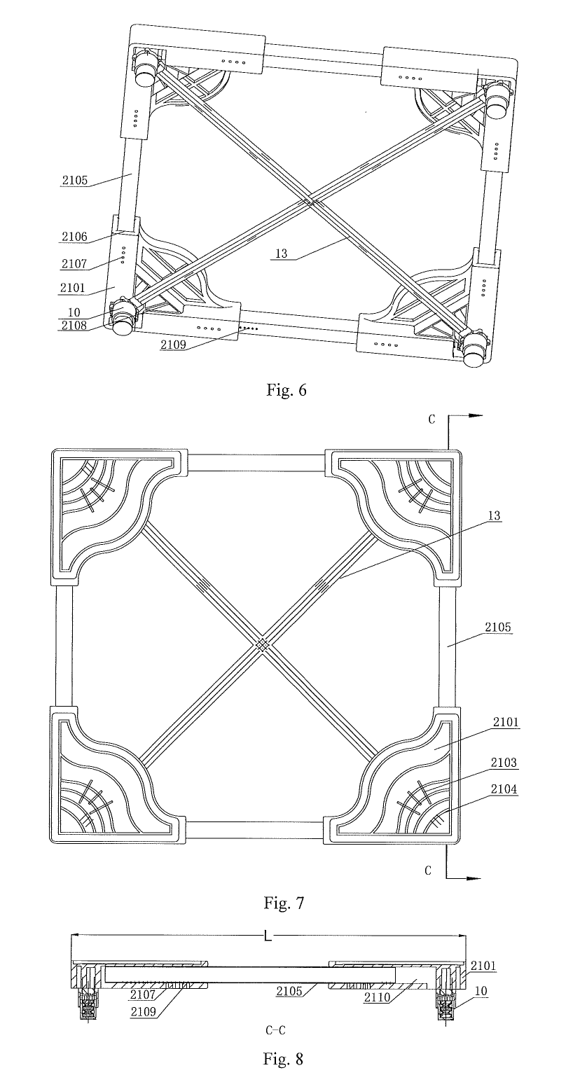

A hydraulic leveling base of the present embodiment is shown in FIGS. 5 to 8. It comprises a bracket 2101 which can be used in a combination and connection manner or be used independently, and a leveling foot 10 being mounted below the bracket 2101. An upper part of bracket 2101 is a supporting surface for bearing. A hydraulic medium is provided inside the leveling foot 10 and flows inside the leveling foot and/or between the leveling feet to realize the leveling.

Below the bracket 2101 of the hydraulic leveling base of the present embodiment is provided with the leveling foot 10. The hydraulic medium flows inside the leveling foot 10 and/or between the leveling feet 10. So the amount of compression of the leveling foot 10 under bigger pressure is large, the leveling foot 10 under smaller pressure extends by the action of the liquid pressure, so that automatic height leveling is realized.

The leveling foot 10 of the hydraulic leveling base of the present embodiment, according to the hydraulic principle, is able to perform timely and effective adjustment based on the practical application environment. It results in better adjustment effect and stronger applicability.

The hydraulic leveling base of the present disclosure can be applied to some occasions or devices which requires relatively high placement stability, to realize better leveling effect.

The bracket 2101 of the present embodiment can be used independently, that is, respectively placing the bracket below the device needing to be supported and leveled. Or, it can also be used in a combined and connected manner, that is, brackets are connected as a whole structure and then the whole structure is placed below the device needing to be supported and leveled. It is selectable according to specific using requirements, with flexible using and wide range of application.

It order to make it easier for the bracket 2101 to be used in a combined and connected manner, the hydraulic leveling base of the embodiment further comprises a horizontal beam 2105 connecting two brackets 2101. The bracket 2101 is provided with a hollow structure 2110 therein. The end of the bracket 2101 is provided with an inserting opening 2106 communicated with the hollow structure 2110. Two ends of the horizontal beam 2105 are respectively inserted into the inserting openings 2106 of two brackets 2101 and are fixed inside the hollow structure 2110, so that two brackets 2101 are connected as a whole structure.

In this embodiment, two brackets 2101 are connected as a whole structure by the horizontal beam 2105. It is not only simple and convenient, but also ensures the stability of the hydraulic leveling base. In addition, in the present embodiment, the number of the brackets 2101 being connected is expanded by adopting the manner of combining and connecting brackets 2101 with horizontal beams 2105. A corresponding number of the brackets 2101, according to the practical application, are combined and connected as a whole hydraulic leveling base.

As a preferable method of the present embodiment, four brackets 2101 are provided. The bracket 2101 comprises two sides perpendicular to each other. The two sides are provided with hollow structures 2110 therein. The ends of two sides are respectively provided with inserting openings 2106. Four horizontal beams 2105 are provided and inserted into the inserting openings 2106 of four brackets 2101 sequentially and fixed in the brackets 2101. So that the four brackets 2101 are connected as one square frame.

The brackets 2101 of the present embodiment are combined and connected to be a hydraulic leveling base of a square frame, being more suitable for the washing machine, the clothes dryer and other household appliances.

Further, the first connecting and fixing holes 2107 are respectively provided on the two sides of the bracket 2101 perpendicular to each other of the present embodiment, in a direction of the hollow structure 2110 being provided. The second connecting and fixing hole 2109 is provided on the horizontal beam 2105. One or at least two first connecting and fixing holes are provided, and at least two or one second connecting and fixing hole are correspondingly provided. The second connecting and fixing hole 2109 is adjusted to correspond to the first connecting and fixing hole 2107, a connecting piece passes through the second connecting and fixing hole 2109 and the first connecting and fixing hole 210 for fixedly connecting, to adjust a length of the horizontal beam 2105 inserted into the hollow structure 2110 of the bracket 2101.

In the present embodiment, one first connecting and fixing hole 2107 corresponds to a plurality of the second connecting and fixing holes 2109. Different second connecting and fixing holes 2109 are aligned with the first connecting and fixing hole by adjusting the horizontal beam 2105. Or, a plurality of the first connecting and fixing holes 2017 correspond to one second connecting and fixing hole 2109. The second connecting and fixing hole 2109 is aligned with different first connecting and fixing holes 2107 by adjusting the horizontal beam 2105. Then the connecting piece passes through the second connecting and fixing hole 2109 and the first connecting and fixing hole 2105 for fixedly connecting. The adjustment of the connection length of the horizontal beam 2105 is realized and the length L between two brackets 2101 is further adjusted, to adapt to multiple washing machines.

Further, an outer edge of the bracket 2101 of the present embodiment is set higher than the supporting surface. That is, the outer edge of the bracket 2101 forms a protrusion edge 2102. The protrusion edge 2102 limits the bottom when the washing machine and other devices are placed on, to ensure the placing stability.

In the present embodiment, a plurality of concentric ripple reinforcing ribs 2104 and radial reinforcing ribs 2103 perpendicular to the reinforcing ribs 2104 are provided on the supporting surface of the bracket 2101. On the one hand, it ensures the strength of the supporting surface of the bracket 2101, and on the other hand, it increases the friction force between the hydraulic leveling base and the washing machine and other devices, to guarantee the placing stability.

Preferably, the ripple reinforcing rib 2104 is an elastic body which is secondary injected and molded on the supporting surface. And the ripple reinforcing rib 2104 is preferred to be made of nitrile rubber. It increases the frictional resistance between the bolt foot 19 of the washing machine and the supporting surface of the bracket 2101, preventing displacement. In order to enhance the strength of the ripple reinforcing rib 2104, the radial reinforcing rib 2103 is made by integrated injection molding.

In addition, the back of the bracket 2101 of the present embodiment is provided with reinforcing ribs 2108, to further enhance the strength of the bracket 2101.

As a preferable method of the present embodiment, the leveling foot 10 comprises a fixed part and a movable part. A hollow chamber is formed by the fixed part and the movable part, and the hollow chamber is provided with the hydraulic medium. The hollow chambers of two adjacent leveling feet are respectively communicated with each other by the high-pressure oil pipe group. Or, all leveling feet are respectively connected with the communicating device through the high-pressure oil pipe group for the mutual communication of the hollow chambers of all leveling feet. Under the action of the pressure, the hydraulic medium can flow between the hollow chambers of the feet communicated with each other. The movable part expands and contracts with the flow of the hydraulic medium to level automatically.

In the present embodiment, the leveling feet 10 of the hydraulic leveling base are communicated with each other. The hydraulic medium of the leveling feet 10 flows between all leveling feet 10. The adjustment effect is better, and the range of adjustment is wider.

As a preferable method of the present embodiment, the hollow chambers of two adjacent leveling feet 10 are communicated with each other by high-pressure oil pipe group 13. A hollow channel for allowing the high-pressure oil pipe group 13 to pass is provided inside the horizontal beam 2015. In this way, the horizontal beam 2015 has a certain protective effect on the high-pressure oil pipe group 13, and the whole structure is more concise and beautiful.

Since the connection length of the horizontal beam 2015 can be adjusted in the present embodiment, and correspondingly, the high-pressure oil pipe 13 provided inside the horizontal beam 2105 is also adjustable or has a variety of selectable length specifications.

Specifically, the high-pressure oil pipe 13 is a telescopic pipe structure for realizing the adjustment of the length. Alternatively, the high-pressure oil pipe 13 is an elastic pipe with relatively high amount of elastic deformation to adapt to the adjustment of the length of horizontal beam 2015. Alternatively, the high-pressure oil pipe 13 has a variety of length specifications. In the practical application, it can be selected and applied according to the connection length of the horizontal beam 2105.

As a preferable method of the present embodiment, all leveling feet 10 are respectively connected with the communicating device 15 through the high-pressure oil pipe group 13 for the mutual communication of the hollow chambers of all leveling feet. The hydraulic leveling base further comprises diagonal connecting beams. Two ends of the diagonal connecting beam are respectively connected with two brackets 2101 set diagonally. A hollow channel for placing the high-pressure oil pipe group and communicating device is provided inside the diagonal connecting beam.

Because the high-pressure oil pipe group 13 is set crossed and the diagonal connecting beams are also set diagonally, in order to set the high-pressure oil pipe group 13 inside the hollow channel inside the diagonal connecting beam, the diagonal connecting beam comprises two cruciate groove structures. High-pressure oil pipe group 13 is correspondingly placed inside the groove of one of the cruciate groove structures, and then another cruciate groove structure is correspondingly buckled on the groove opening of the cruciate groove structure mentioned above, to realize that the high-pressure oil pipe group 13 is provided inside the hollow channel inside the diagonal connecting beam. It not only has a protective effect for the high-pressure oil pipe 13, but also makes the whole structure more concise and beautiful.

### Embodiment 2

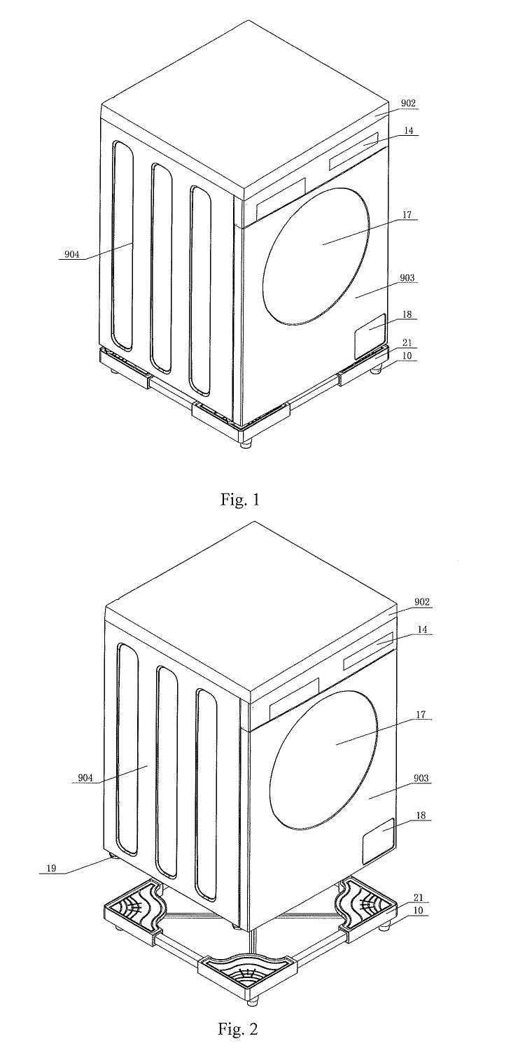

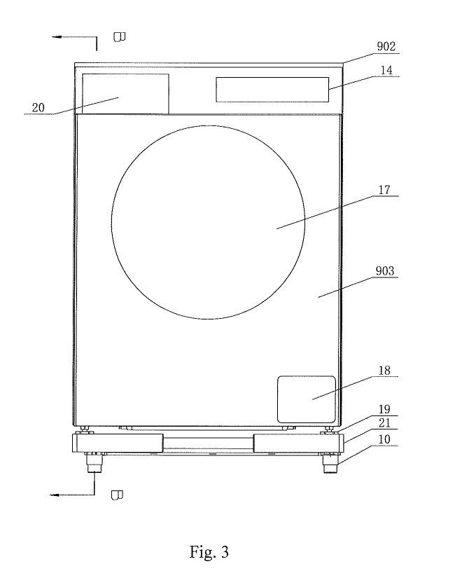

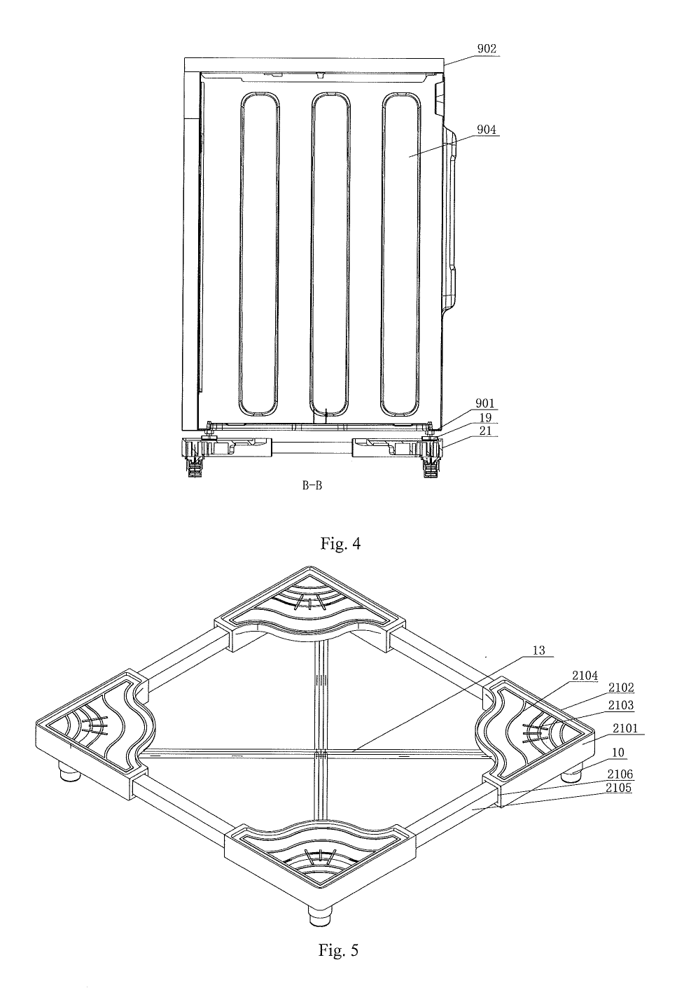

As shown in FIG. 1 to 4, the washing machine of the present embodiment is provided with a hydraulic leveling base 21, comprising a housing 9 and a drum assembly provided inside the housing 9 for washing clothes. The four corners of the bottom of the housing 9 are placed on the four brackets 2101 of the hydraulic leveling base 21.

The washing machine of the present embodiment is placed on the hydraulic leveling base 21 to realize the automatic leveling. The hydraulic leveling base is also able to self-level on the partial load during a washing process and a dewatering process of the washing machine, and then lower vibration and less noise is achieved.

Specifically, the housing 9 comprises a bottom board 901. Four corners of the bottom board 901 are provided with the bolt feet 19. The bolt feet 19 are respectively placed on the four brackets 2101 of the hydraulic leveling base 21. In this way, it will not change the structure of the existing washing machine, and the users can choose whether or not to equip the hydraulic leveling base 21. It results in high selectivity.

In addition, in the present disclosure, the original bolt foot 19 can be removed. The four corners of the bottom board 901 of the housing 9 are placed directly on the hydraulic leveling base 21. Without changing the structure of the washing machine, the direct combination achieves better automatic leveling effect.

A drum washing machine of the present disclosure is taken as an example. The drum washing machine comprises:

a housing 9 comprising an upper board 902, a front board 903, a side board 904 and a bottom board 901 for keeping an entire frame and an exterior appearance of the washing machine;

a detergent box 20 for storing power detergent, liquid detergent or softener;

a control panel 14 for operating the washing machine;

a door 17 for opening to take out or put in clothes;

a bottom board 901 for installing the leveling foot to realize the washing machine automatic adjustment of height; and

a cover board 18 being mounted below the front board 903.

The embodiment takes the drum washing machine as an example to describe the principle and the method of automatic leveling of the drum washing machine. What is easy to associate with is that the hydraulic leveling base can be applied to a pulsator washing machine.

The present embodiment takes the washing machine as an example to describe the principle and the method of automatic leveling of the washing machine. What is easy to associate with is that the hydraulic leveling base can be applied to refrigerators, freezers, dishwashers and other household appliances.

### Embodiment 3

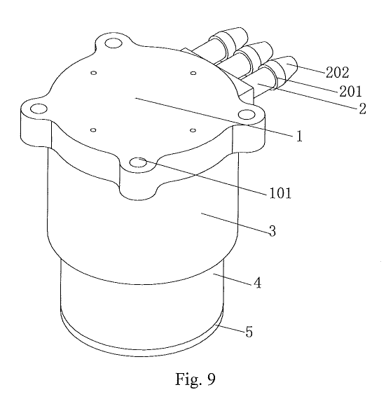

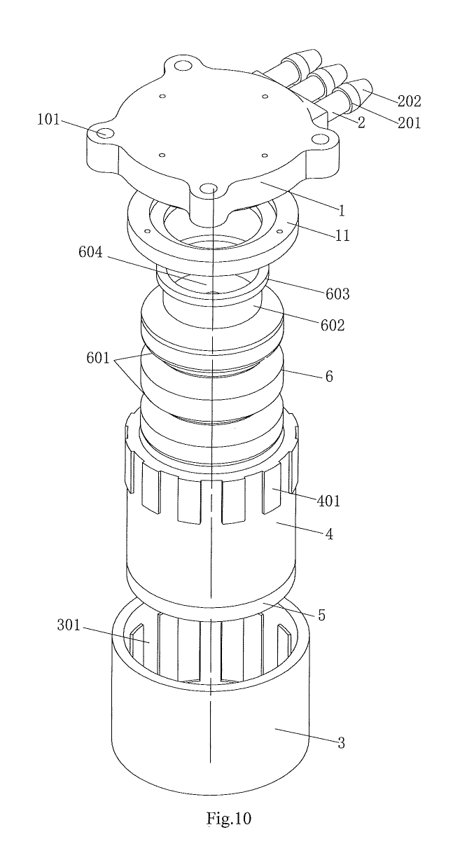

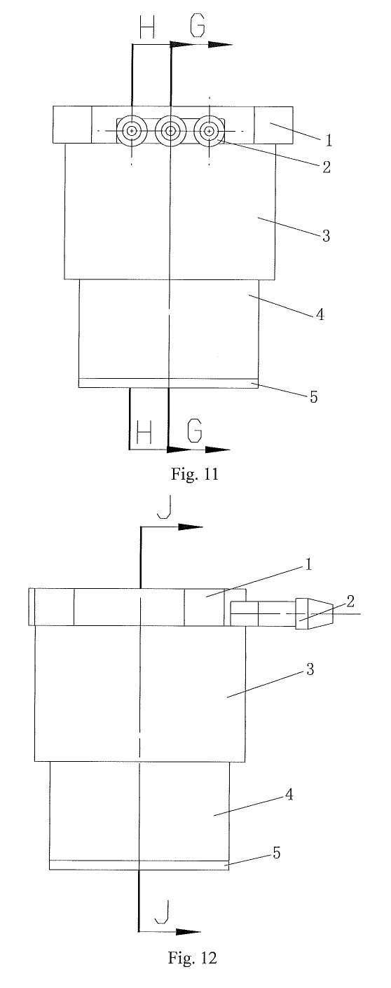

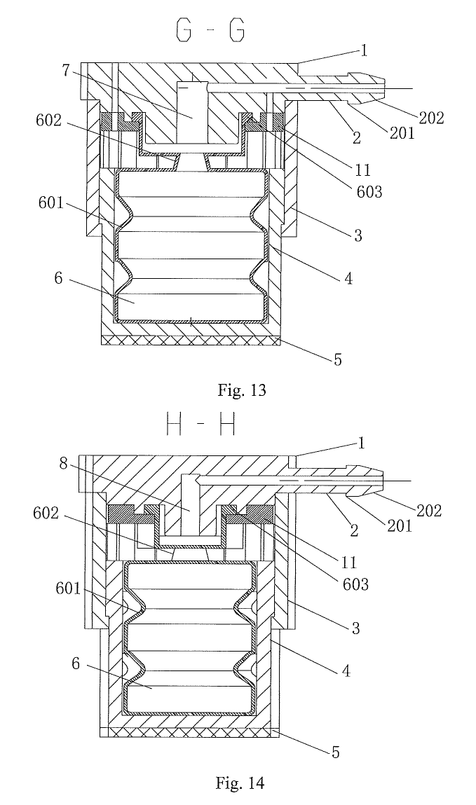

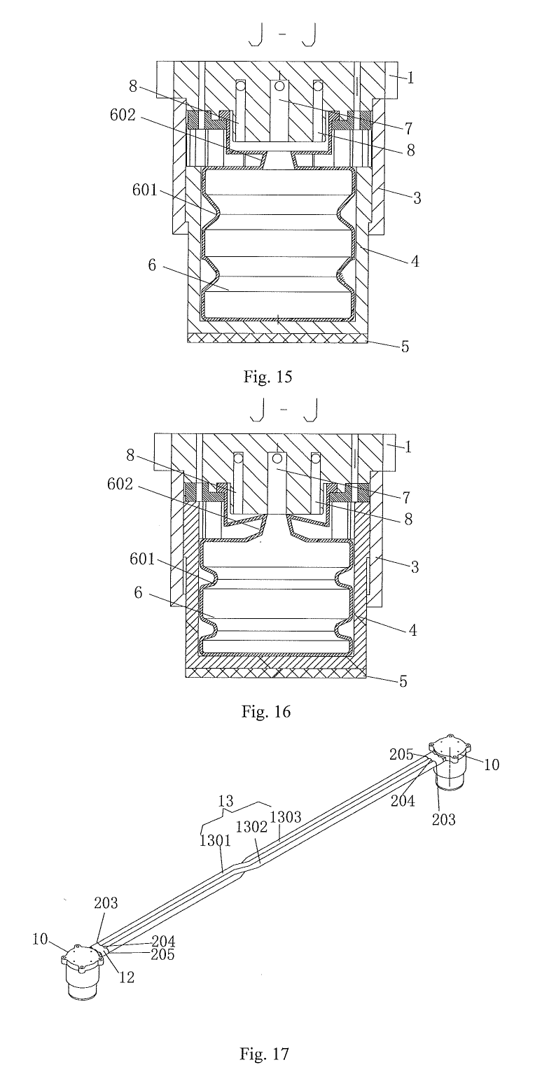

As shown in FIGS. 9 to 19, the leveling foot 19 of the present embodiment comprises a foot base, a flexible accommodating body 6 and an adjustable foot 4. The foot base has a hollow chamber therein, and the feet base are respectively provided with an orifice 7 and a valve opening 8 which are communicated with the hollow chamber. The orifice 7 and the valve opening 8 are respectively aconnected with high-pressure oil pipes. The flexible accommodating body 6 is provided in the hollow chamber, and has an accommodating chamber. The accommodating chamber is provided with a hydraulic medium. And the hydraulic medium inside a plurality of feet can flow mutually through the high-pressure oil pipes under the action of pressure. One end of the adjustable 4 is relatively slidably set in the hollow chamber and the flexible accommodating body 6 is in contact with or connected with the adjustable foot 4.

The leveling foot 10 of the present embodiment, according to the hydraulic principle, is provided with the hydraulic medium therein. Under different pressure, the foot is able to automatically execute adjustment due to the fluidity of the hydraulic medium.

Since the orifice 7 and the valve opening 8 of the leveling foot 10 of the present embodiment are respectively connected with high-pressure oil pipe, and the feet is communicated by the high-pressure oil pipe. The range of adjustment is larger and the effect of adjustment is better.

Since the leveling foot 10 of the present embodiment holds the hydraulic medium in the enclosed flexible accommodating body 6, and the flexible accommodating body 6 is placed inside the adjustable foot 4. It effectively solves the problem of the leakage of the hydraulic medium and ensures the working stability of the foot.

Therefore, the structure of the leveling foot 10 of the present embodiment is simple and the cost is low. It is easy to use and has high reliability, and it can remarkably reduce the vibration, reduce noise, and improve the comfort of the experience of the washing machine for users.

Further, the foot base of the present embodiment comprises a base body 1 and a sheath 3 which are connected with each other. The base is provided with a groove. A pressing ring 11 is provided between the base body 1 and the sheath 3. One end of the flexible accommodating body 6 is provided with an opening 604, and the opening is provided with a sealing mechanism 603. One end of the sealing mechanism 603 is installed inside the groove, the other end keeps the sealing connection between the flexible accommodating body 6 and the base body 1 under the press fit of the pressing ring 11.

Further, the base body 1 of the present embodiment is provided with an orifice 7 and at least two valve openings 8. The orifice 7 and the valve openings 8 are respectively communicated with the opening 604 of the flexible accommodating body, and the orifice 7 is provided in the middle of the valve openings 8. Under a first pressure, the orifice 7 and the valve opening 8 all keep conductive. Under a second pressure, the flexible accommodating body 6 is compressed to block the valve opening 8, and the orifice 7 keeps conductive.

The base body 1 of the present embodiment is provided with a plurality of oil nipples 2, and the oil nipple 2 is respectively communicated with the orifice 7 and the valve opening 8. The oil nipple 2 is provided with an anti-stripping boss 201. The outer diameter of the anti-stripping boss 201 is larger than the inner diameter of the high-pressure oil pipe, which is specifically 0.1 mm-1.5 mm.

The initiating end of the oil nipple is provided with a guiding mechanism 202. Specifically, the guiding mechanism 202 is a chamfering structure, which makes the initiating end of the oil nipple easy to be inserted into the oil pipe.

Specifically, as shown in the FIG. 17, the leveling foot of the present embodiment comprises an orifice 7 and two valve openings 8. The orifice 7 is provided between the two valve openings 8. The orifice 7 is connected with the second oil nipple 204, and the two valve openings 8 are respectively connected with the first oil nipple 203 and the third oil nipple 205.

The base body 1 is provided with a plurality of mounting holes 101 and can be fastened to the bottom board 901 of the washing machine by the bolts or the screws. Therefore, it is possible to conceive that a screw column is provided in the center of the base body 1 and is screwed into the bottom board 901.

In the leveling foot of the present embodiment, a small-diameter structure 602 is provided between the opening 604 of the flexible accommodating body 6 and the hollow chamber. The inner diameter of the small-diameter structure 602 is smaller than the inner diameter of the opening 604 and the inner diameter of the hollow chamber.

The middle of the small-diameter structure 602 of the flexible accommodating 6 is provided with an oil hole which is kept in conduction with the opening 604. The small-diameter structure 602 is characterized in that the hydraulic medium can always flow in or out of the orifice 7 and valve opening 8 through the oil hole. Once the pressure of the adjustable foot 4 is too high, the rubber around the small-diameter structure 602 will fit in the base body 1 to seal the valve opening 8, resulting in greater throttling effect.

The flexible accommodating body 6 of the present embodiment is provided with a bellows section. The bellows section is provided with a hollow chamber therein. The bellows section makes the flexible accommodating body 6 forms unnecessary crimps while stretching and being compressed, so as to improve the service life.

A vertical limiting groove 301 is provided on the inner wall of the sheath 3 of the leveling foot 10 of the present embodiment. A vertical limiting protrusion 401 is correspondingly provided on the outer wall of the adjustable foot 4. The vertical limiting groove 301 cooperates with the vertical limiting protrusion 401 to limit the vertically up and down telescopic movement of the adjustable foot. The setting has the following advantages:

(1) making the adjustable foot 4 move up and down vertically, without lateral deviation.

(2) preventing the rotation movement of the adjustable foot 4 on the sheath 3, greatly reducing the vibration of the washing machine.

(3) effectively preventing the adjustable foot 4 from departing from the sheath 3, and avoiding the burst of the flexible accommodating body 6 or the burst due to sharp objects when it is in direct contact with the ground.

As shown in FIG. 17, the leveling foot of the present embodiment comprises a first foot and a second foot. The first foot and the second foot are respectively provided with the orifice 7 and the valve opening 8. The orifice 7 and the valve opening 8 are respectively communicated with the hollow chamber. The orifice 7 of the first foot and the valve opening 8 of the second foot are connected through high-pressure oil pipes. The valve opening 8 of the first foot and the orifice 7 of the second foot are connected through the high-pressure oil pipe.

Specifically, the first foot and the second foot of the present embodiment are respectively provided with an orifice 7 and two valve openings 5 consisting of the first valve opening and the second valve opening. The orifice 7, the first valve opening and the second valve opening are respectively communicated with the hollow chamber. The orifice 7 of the first foot and the first valve opening of the second foot are connected through the second high-pressure oil pipe 1302. The first valve opening of the first foot and the orifice 7 of the second foot are connected through the first high-pressure oil pipe 1301. The second valve opening of the first foot and the second valve opening of the second foot are connected through the third high-pressure oil pipe 1303. The first high-pressure oil pipe 1301, the second high-pressure oil pipe 1302 and the third high-pressure oil pipe 1303 form a hydraulic pipe group 13.

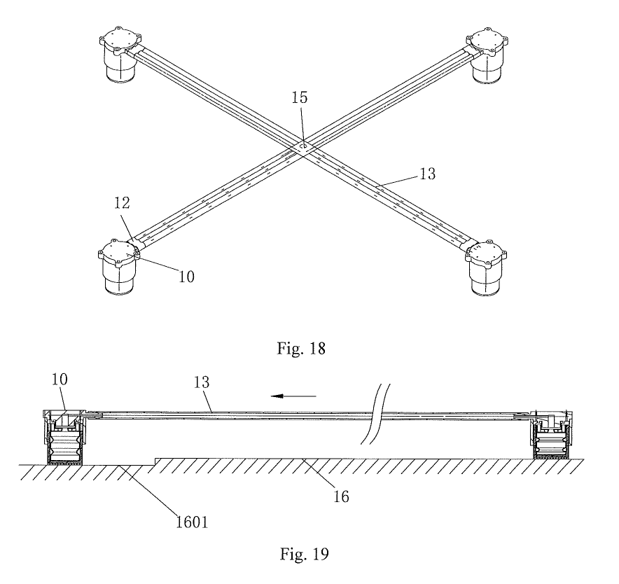

As shown in FIG. 18, the four brackets 2101 of the hydraulic leveling base 21 is provided with at least four feet 10 which are communicated with each other. Each foot 10 is provided with the hydraulic medium and the gas. Under the first range of pressure, the hydraulic medium and the gas inside each foot 10 interact with each other to realize the expansion and the contraction of the move part, to level automatically. Under the second range of pressure, the hydraulic medium and the gas inside the communicated feet 10 interact with each other to realize the expansion and the contraction of the move part, to level automatically. This way realizes the communication between all the feet, and the hydraulic medium can flow between all the feet. The range of adjustment is larger, and the effect of adjustment is better.

Specifically, an enclosed chamber which is provided with the hydraulic medium and the gas is provided inside the foot 10. The enclosed chamber is communicated with the high-pressure oil pipe group 13. The high-pressure oil pipe group 13 of each foot 13 is respectively communicated with a communicating device 15 to achieve the mutual communication between all feet 10.

The leveling foot of the present embodiment uses the gas as the elastic medium and the liquid medium as the force transmission medium. It not only has a good ability of cushioning, but also has a damping effect. At the same time, it can also adjust the height of the foot itself according to the size of the pressure it withstands.

As shown in FIG. 19, it specifically explains the principle of leveling. After the washing machine is installed, it results in different horizontal height of different feet because the ground is uneven, and the position of the foot located in a ground pit 2601 is low.

It is possible to know that the foot in the high position bears the weight of the washing machine at first and bears greater gravity. The foot in the low position may bear smaller gravity due to the failure of supporting. The adjustable foot of the foot in the high position moves upward under greater pressure. The height of the whole foot gets small to make the volume of the hollow chamber of the flexible accommodating body 21 provided with hydraulic oil compressed and reduced, forcing the hydraulic medium to flow into the orifice or the valve opening and flow into the foot in the lower position through the high-pressure oil pipe group. So the hydraulic medium of the flexible accommodating body 6 of the foot in the low position gets more and more and the flexible accommodating body 6 expands to drive the adjustable foot to extend.

When hydraulic pressures of the leveling foot in the higher position and the leveling foot in the lower position are equal, the hydraulic medium no longer flows through the high-pressure oil pipe group, the relative positions of the adjustable foot and the bottom board of the washing machine no longer change, and the automatic adjustment of the leveling feet of the washing machine is completed.

In the washing process or the dewatering process of the washing machine, because the hydraulic medium still flows slowly to self-level, the vibration of the washing machine is greatly reduced.

Further illustrations which are necessary for the above embodiments are:

Every two of the feet of the embodiments of the present disclosure are communicated. It can be three or more and the number N≥2, preferably two. It costs the lowest and can achieve better results.

In the embodiment of the present disclosure, the four end openings of the communicating device 15 are applied to be respectively connected with four feet. It is reasonable that three, five, six or N end openings of the communicating device 15 are applied, and the end openings are respectively connected with three, five, six or N feet.

The above-described embodiments apply four leveling feet which is the most suitable merely in the situation of being capable of achieving the described functions, to control the cost to the minimum. The foregoing is merely illustrative of the preferred embodiments of the present disclosure and is not intended to be limiting of the present disclosure. While the disclosure has been disclosed by way of example with reference to the preferred embodiments, it is not intended to be limiting of the disclosure. Any person skilled in the art will, without departing from the scope of the technical solution of the present disclosure, may make use of the technical contents of the above-mentioned tips to make some alterations or modifications to equivalent embodiments, but without departing from the scope of the technical solution of the present disclosure. Any and all modifications, equivalents, and modifications of the foregoing embodiments are within the scope of the present disclosure without departing from the spirit of the technical solution of the present disclosure in accordance with the technical details of the present disclosure.

1. A hydraulic leveling base, comprising a bracket being used in a combination and connection manner or independently, and a leveling foot mounted below the bracket, wherein,
a supporting surface for bearing is on an upper part of the bracket,
a hydraulic medium is provided inside the leveling foot and flows inside the leveling foot and/or between the leveling feet for automatic leveling.

2. The hydraulic leveling base according to claim 1, further comprising a horizontal beam connecting two brackets,
wherein the bracket is provided with a hollow structure therein, and an end of the bracket is provided with an inserting opening communicated with the hollow structure, and
two ends of the horizontal beam are respectively inserted into the inserting openings of two brackets and are fixed inside the hollow structure, so that two brackets are connected as a whole structure.

3. The hydraulic leveling base according to claim 2, wherein four brackets are provided,
the bracket comprises two sides perpendicular to each other,
the two sides are provided with the hollow structure therein, and the ends of two sides are respectively provided with the inserting opening; and
four horizontal beams are provided and inserted into the inserting openings of four brackets sequentially and fixed in the brackets, so that four brackets are connected as one square frame.

4. The hydraulic leveling base according to claim 3, wherein first connecting and fixing holes are respectively provided on the two sides of the bracket perpendicular to each other in a direction of the hollow structure being provided, a second connecting and fixing hole is provided on the horizontal beam,
one or at least two first connecting and fixing holes are provided, and at least two or one second connecting and fixing hole is correspondingly provided,
the second connecting and fixing hole is adjusted to correspond to the first connecting and fixing hole, and
a connecting piece passes through the second connecting and fixing hole and the first connecting and fixing hole for fixedly connecting, to adjust a length of the horizontal beam inserted into the hollow structure of the bracket.

5. The hydraulic leveling base according to claim 1, wherein a plurality of concentric ripple reinforcing ribs and radial reinforcing ribs perpendicular to the ripple reinforcing ribs are provided on the supporting surface of the bracket, and an outer edge of the bracket is set higher than the supporting surface.

6. The hydraulic leveling base according to claim 1, wherein the leveling foot comprises a fixed part and a movable part, a hollow chamber is formed by the fixed part and the movable part, and the hollow chamber is provided with the hydraulic medium;
the hollow chambers of two adjacent leveling feet are respectively communicated with each other by the high-pressure oil pipe group, or all leveling feet are respectively connected with a communicating device through the high-pressure oil pipe group to for mutual communication of the hollow chambers of all leveling feet, and
under the action of the pressure, the hydraulic medium flows between the hollow chambers of the feet communicated with each other, and the movable part expands and contracts with the flow of the hydraulic medium to level automatically.

7. The hydraulic leveling base according to claim 6, wherein the hollow chambers of two adjacent leveling feet are communicated with each other by the high-pressure oil pipe group, and
a hollow channel for allowing the high-pressure oil pipe group to pass is provided inside the horizontal beam.

8. The hydraulic leveling base according to claim 6, wherein all leveling feet are respectively connected with the communicating device through the high-pressure oil pipe group for the mutual communication of the hollow chambers of all leveling feet;
the hydraulic leveling base comprises diagonal connecting beams, two ends of the diagonal connecting beam are respectively connected with two brackets set diagonally; and
a hollow channel for placing the high-pressure oil pipe group and communicating device is provided inside the diagonal connecting beam.

9. A washing machine with the hydraulic leveling base according to claim 1, comprising a housing and a drum assembly inside the housing for washing clothes, and four corners of the bottom of the housing are placed on four brackets of the hydraulic leveling base.

10. The washing machine according to claim 9, wherein the housing comprises a bottom board, four corners of the bottom board are provided with bolt feet, and the bolt feet are respectively placed on the four brackets of the hydraulic leveling base.

11. The hydraulic leveling base according to claim 2, wherein the leveling foot comprises a fixed part and a movable part, a hollow chamber is formed by the fixed part and the movable part, and the hollow chamber is provided with the hydraulic medium;
the hollow chambers of two adjacent leveling feet are respectively communicated with each other by the high-pressure oil pipe group, or all leveling feet are respectively connected with a communicating device through the high-pressure oil pipe group to for mutual communication of the hollow chambers of all leveling feet, and
under the action of the pressure, the hydraulic medium flows between the hollow chambers of the feet communicated with each other, and the movable part expands and contracts with the flow of the hydraulic medium to level automatically.

12. The hydraulic leveling base according to claim 3, wherein the leveling foot comprises a fixed part and a movable part, a hollow chamber is formed by the fixed part and the movable part, and the hollow chamber is provided with the hydraulic medium;
the hollow chambers of two adjacent leveling feet are respectively communicated with each other by the high-pressure oil pipe group, or all leveling feet are respectively connected with a communicating device through the high-pressure oil pipe group to for mutual communication of the hollow chambers of all leveling feet, and
under the action of the pressure, the hydraulic medium flows between the hollow chambers of the feet communicated with each other, and the movable part expands and contracts with the flow of the hydraulic medium to level automatically.

13. The hydraulic leveling base according to claim 4, wherein the leveling foot comprises a fixed part and a movable part, a hollow chamber is formed by the fixed part and the movable part, and the hollow chamber is provided with the hydraulic medium;
the hollow chambers of two adjacent leveling feet are respectively communicated with each other by the high-pressure oil pipe group, or all leveling feet are respectively connected with a communicating device through the high-pressure oil pipe group to for mutual communication of the hollow chambers of all leveling feet, and
under the action of the pressure, the hydraulic medium flows between the hollow chambers of the feet communicated with each other, and the movable part expands and contracts with the flow of the hydraulic medium to level automatically.

14. The hydraulic leveling base according to claim 5, wherein the leveling foot comprises a fixed part and a movable part, a hollow chamber is formed by the fixed part and the movable part, and the hollow chamber is provided with the hydraulic medium;
the hollow chambers of two adjacent leveling feet are respectively communicated with each other by the high-pressure oil pipe group, or all leveling feet are respectively connected with a communicating device through the high-pressure oil pipe group to for mutual communication of the hollow chambers of all leveling feet, and
under the action of the pressure, the hydraulic medium flows between the hollow chambers of the feet communicated with each other, and the movable part expands and contracts with the flow of the hydraulic medium to level automatically.

15. The hydraulic leveling base according to claim 11, wherein the hollow chambers of two adjacent leveling feet are communicated with each other by the high-pressure oil pipe group, and
a hollow channel for allowing the high-pressure oil pipe group to pass is provided inside the horizontal beam.

16. The hydraulic leveling base according to claim 12, wherein the hollow chambers of two adjacent leveling feet are communicated with each other by the high-pressure oil pipe group, and
a hollow channel for allowing the high-pressure oil pipe group to pass is provided inside the horizontal beam.

17. The hydraulic leveling base according to claim 13, wherein the hollow chambers of two adjacent leveling feet are communicated with each other by the high-pressure oil pipe group, and
a hollow channel for allowing the high-pressure oil pipe group to pass is provided inside the horizontal beam.

18. The hydraulic leveling base according to claim 14, wherein the hollow chambers of two adjacent leveling feet are communicated with each other by the high-pressure oil pipe group, and
a hollow channel for allowing the high-pressure oil pipe group to pass is provided inside the horizontal beam.

19. The hydraulic leveling base according to claim 11, wherein all leveling feet are respectively connected with the communicating device through the high-pressure oil pipe group for the mutual communication of the hollow chambers of all leveling feet;
the hydraulic leveling base comprises diagonal connecting beams, two ends of the diagonal connecting beam are respectively connected with two brackets set diagonally; and
a hollow channel for placing the high-pressure oil pipe group and communicating device is provided inside the diagonal connecting beam.

20. The hydraulic leveling base according to claim 12, wherein all leveling feet are respectively connected with the communicating device through the high-pressure oil pipe group for the mutual communication of the hollow chambers of all leveling feet;
the hydraulic leveling base comprises diagonal connecting beams, two ends of the diagonal connecting beam are respectively connected with two brackets set diagonally; and
a hollow channel for placing the high-pressure oil pipe group and communicating device is provided inside the diagonal connecting beam.
